(19) United States
(12) Patent Application Publication
(10) Pub. No.: US 2007/0030474 A1
(43) Pub. Date: Feb. 8, 2007

(54) Optical range finder

(76) Inventor: Dezhong Yang, Nanjing (CN)

Correspondence Address: WALLENSTEIN & WAGNER, LTD., 311 SOUTH WACKER DRIVE, 53RD FLOOR, CHICAGO, IL, 60606, US

(21) Appl. No.: 11/500,226

(22) Filed: Aug. 8, 2006

(30) Foreign Application Priority Data
Aug. 8, 2005 (CN) 200520074286.4

(51) Int. Cl. G01C 3/08; G02B 23/00

(52) U.S. Cl. 356/4.01; 359/399; 356/4.05

(57) ABSTRACT

The present invention is intended to provide an optical range finder that is simple in structure and is easy to manufacture. The optical range finder includes a light emitter for emitting a measurement light, an aligning objective lens system for aligning the measurement light emitted from said light emitter, a receiving objective lens system for receiving and converging the reflected measurement light, a light receiver for receiving the reflected measurement light passing through the receiving objective lens system and outputting a corresponding electrical signal, and a controlling and analyzing circuit for controlling, analyzing and processing the electrical signal so as to determine the measured distance. The receiving objective lens system further includes a first optical portion for receiving the reflected measurement light of a long-distance measured object and converging and projecting it onto the light receiving surface of the light receiver, and a second optical portion for receiving the reflected measurement light of a short-distance measured object and converging and projecting it onto the light receiving surface of said light receiver. The receiving objective lens system is divided into a first and a second optical portions for receiving the long-distance and short-distance reflected measurement light, respectively, so as to avoid moving the light receiving surface or adding other optical deflecting element in the receiving light path, simplify the internal structure of the optical range finder, reduce the difficulty in manufacture, and more help to obtain a large scale yield.

### CROSS-REFERENCE TO RELATED APPLICATIONS

This application claims priority to Chinese Application No. 200520074286.4, filed Aug. 8, 2005, the entire disclosure of which is incorporated herein by reference. Priority to this application is claimed under 35 U.S.C. 119, 120 and/or 365.

### TECHNICAL FIELD

The invention relates to an optical range finder, particularly to an optical range finder that determines the distance to be measured by measuring difference between a measuring light emitted and a measuring light returned from the measured object.

### BACKGROUND OF THE INVENTION

Optical range finders are widely used in earth measurements, engineering measurements, and other measurement activities done often in daily life. European patent EP 00701702 B 1 published on Feb. 5, 1997, discloses an optical range finder which emits a visible measurement light to a measured object, and receives the reflected measurement light back from the measured object, and then measures the difference between them to determine the distance from the range finder to the measured object. To solve the problem of an image formed by the reflected measurement light back from a short-distance object after passing through the receiving objective lens may deviate from the focal point of receiving objective lens, EP 00701702 B 1 discloses two solutions: 1) using a mechanical structure to drive the light receiving surface to move in the focusing surface of receiving objective lens; and 2) fixing the light receiving surface, adding an optical deflecting element at an appropriate position before or after the receiving objective lens, to deflect the short-distance reflected light onto the light receiving surface. However, both use a mechanical structure, and adding the optical deflecting element may complicate the range finder in structure, making it more difficult to manufacture.

The present invention is provided to solve the problems discussed above and other problems, and to provide advantages and aspects not provided by prior optical range finders of this type. A full discussion of the features and advantages of the present invention is deferred to the following detailed description, which proceeds with reference to the accompanying drawing.

### SUMMARY OF THE INVENTION

The present invention is intended to provide an optical range finder that is simple in structure and easy to manufacture.

To achieve the above object, the optical range finder according to the present invention includes a light emitter for emitting a measurement light, an aligning objective lens system for aligning the measurement light emitted from the light emitter, a receiving objective lens system for receiving and converging the reflected measurement light, a light receiver for receiving the reflected measurement light passing through the receiving objective lens system, and a controlling and analyzing circuit which controls the light emitter to emit light, analyzes and processes electrical signals output from the light receiver to determine the distance to be measured. The receiving objective lens system further comprises a first optical portion that receives a long-distance reflected measurement light and images it onto the light receiving surface of the light receiver, and a second optical portion that receives a short-distance reflected measurement light and converges and projects it onto the light receiving surface of the light receiver. The receiving objective lens system is divided into a first and a second optical portions for receiving the long-distance and short-distance reflected measurement light, respectively, so as to avoid moving the light receiving surface or adding other optical deflecting elements in the receiving light path, which simplifies the internal structure of the optical range finder, reduces the difficulty of manufacture, and helps obtain a large scale yield.

In one preferred embodiment of the present invention, the optical range finder has a receiving objective lens having a first optical portion with an optical axis which is parallel to the optical axis of aligning objective lens system.

In one preferred embodiment of the present invention, the optical range finder has a light receiving surface of the light receiver which is fixed at a focal point of the first optical portion of the receiving objective lens system.

In one preferred embodiment of the present invention, the optical range finder has a first and a second optical portion of the receiving objective lens system that do not overlap with each other.

In one preferred embodiment of the present invention, the optical range finder has two optical portions of the receiving objective lens system which comprise two lenses separated from each other.

In one preferred embodiment of the present invention, the optical range finder has a receiving objective lens system that is a complex lens.

Other features and advantages of the invention will be apparent from the following specification taken in conjunction with the following drawing.

### BRIEF DESCRIPTION OF THE DRAWINGS

To understand the present invention, it will now be described by way of example, with reference to the accompanying drawing in which:

FIG. 1 is an schematic view of the optical range finder according to the present invention.

### DETAILED DESCRIPTION

While this invention is susceptible of embodiments in many different forms, there is shown in the drawing and will herein be described in detail preferred embodiments of the invention with the understanding that the present disclosure is to be considered as an exemplification of the principles of the invention and is not intended to limit the broad aspect of the invention to the embodiments illustrated.

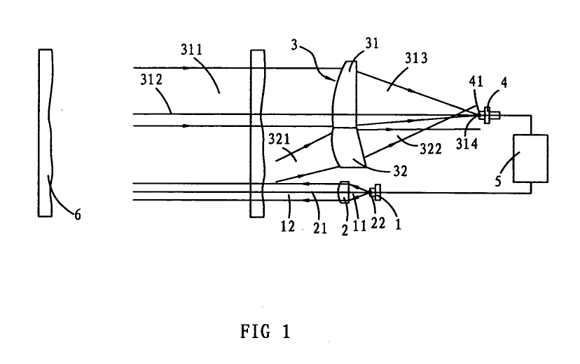

FIG. 1 shows one preferred embodiment of an optical range finder according to the present invention. In one preferred embodiment, the optical range finder comprises a light emitter 1, an aligning objective lens system 2, a receiving objective lens system 3, a light receiver 4, and a controlling and analyzing circuit 5.

The light emitter 1 is preferably a visible light emitter such as a semiconductor laser diode. In the other embodiments, the light emitter 1 may also be other appropriate light sources. The controlling and analyzing circuit 5 controls the light-emitting time of the light emitter 1 and the performance such as frequency, intensity and the like, of the emitted light beam therefrom. The light emitter 1 is provided on the optical axis 21 of the aligning objective lens system 2, and its laser emitting point is located substantially at the focal point 22 of the aligning objective lens system 2. The divergent measurement light beam 11 emitted from the light emitter 1 becomes an aligned measurement light beam 12 after passing through the aligning objective lens system 2.

The aligned measurement light beam 12 diffuses on the surface of measured object 6, in which a part of measurement light is reflected onto the receiving objective lens system 3. The long-distance measured object may be considered to locate at an infinite distance, in this case, the reflected measurement light beam received by the receiving objective lens system 3 is a parallel light beam. The receiving objective lens system 3 includes a first optical portion 31 for receiving the parallel reflected measurement light beam 311 of a long-distance measured object. The first optical portion 31 has an optical axis 312 parallel to the optical axis 21 of the aligning objective lens system 2. The parallel reflected measurement light beam 311 becomes a convergent light beam 313 and images at the focal point 314 of the first optical portion 31 after passing through the first optical portion 31 of the receiving objective lens system 3. The longer the distance is, the weaker the reflected measurement light received by the first optical portion 31 is, and thus the light receiving surface 41 of the light receiver 4 is provided at the focal point 314 of the first optical portion 31 to receive sufficiently the long-distance reflected measurement light. The light receiver 4 receives the reflected measurement light, converts it into a corresponding electrical signal and outputs it to the controlling and analyzing circuit 5, so that the controlling and analyzing circuit 5 analyzes the difference between the measurement light received by the light receiver 4 and the measurement light emitted from the light emitter 1 to determine the measured distance depending on that difference. As known to a person skilled in the art, such difference may be time difference or phase difference. The light receiver 4 herein includes a photovoltaic conversion device that may be an avalanche fotodiode, and also be other appropriate photovoltaic conversion device such as a PIN fotodiode and the like. In this preferred embodiment, the light receiving surface of the light receiver is the photosensitive surface of the photovoltaic conversion device. However, in other embodiments, it may also be the light receiving surface of a light guide device (e.g. light guide fiber) for guiding a light beam to the photosensitive surface of the photovoltaic conversion device.

For the receiving objective lens system 3, the reflected measurement light beam 321 of a short-distance measured object (as the broken line shown in FIG. 1) is an inclined divergent light beam relative to the optical axis 312 of the first optical portion 31, thus, if the first optical portion 31 receives the short-distance reflected measurement light beam 321, the image formed will deviate from the focal point 314 of the first optical portion 31 both in and vertical to the direction of the optical axis 312. For this end, the receiving objective lens system 3 further includes another second optical portion 32 for receiving a short-distance reflected measurement light beam 321. The second optical portion 32 is located to the side of the first optical portion 31 and is not covered by the first optical portion 31. The short-distance reflected measurement light beam 321 is converged to be a light beam 322 after passing through the second optical portion 32. Since the intensity of short-distance reflected light is large enough, an electrical signal with enough intensity may be produced if only a part of the light beam 322 is projected onto the light receiving surface 41; where the light beam 322 focuses may change greatly when measuring different distances within a short-distance range, thus it can meet the measuring requirements if only the second optical portion 32 is pre-designed and adjusted so that the light beam 322 within the short-distance range is always focused at an appropriate location before or after the light receiving surface 41.

In this embodiment, the first optical portion 31 and the second optical portion 32 of the receiving objective lens system 3 are formed together to be a complex lens. In other embodiments, the first optical portion 31 and the second optical portion 32 of the receiving objective lens system 3 may also be two lenses separated with each other.

To avoid adding a mechanical means for moving the light receiving surface of the light receiver or other optical element for deflecting again the light beam, the receiving objective lens system is divided into two parts for receiving the long-distance and short-distance reflected measurement light, so as to simplify the internal structure of the optical range finder, reduce the difficulty in manufacture, and more help to obtain a large scale yield.

While the specific embodiments have been illustrated and described, numerous modifications come to mind without significantly departing from the spirit of the invention, and the scope of protection is only limited by the scope of the accompanying Claims.

What is claimed is:

1. An optical range finder, comprising:
a light emitter for emitting a measurement light;
an aligning objective lens system for aligning the measurement light emitted from said light emitter;
a receiving objective lens system for receiving and converging a reflected measurement light;
a light receiver for receiving the reflected measurement light passing through the receiving objective lens system and outputting a corresponding electrical signal; and
a controlling and analyzing circuit for controlling the light emitted by said light emitter, and analyzing and processing the electrical signal output from said light receiver, so as to determine a measured distance, the receiving objective lens system further comprising a first optical portion for receiving the reflected measurement light of a long-distance measured object and converging and projecting it onto the light receiving surface of the light receiver, and a second optical portion for receiving the reflected measurement light of a short-distance measured object and converging and projecting it onto the light receiving surface of said light receiver.

2. The optical range finder according to claim 1, wherein an optical axis of the first optical portion of said receiving objective lens system is parallel to an optical axis of said aligning objective lens system.

3. The optical range finder according to claim 1, wherein the light receiving surface of said light receiver is fixed at the focal point of the first optical portion of said receiving objective lens system.

4. The optical range finder according to claim 1, wherein the light emitter is a visible light emitter.

5. The optical range finder according to claim 1, wherein the first and the second optical portions of said receiving objective lens system are not overlapped with each other.

6. The optical range finder according to claim 5, wherein the two optical portions of said receiving objective lens system are divided into two lenses separated with each other.

7. The optical range finder according to claim 5, wherein said receiving objective lens system is a complex lens.

8. An optical range finder, comprising:
a light emitter;
an aligning objective lens system;
a receiving objective lens system;
a light receiver; and
a controlling and analyzing circuit.

9. The optical range finder of claim 1, wherein the light emitter emits a measurement light.

10. The optical range finder of claim 9, wherein the aligning objective lens aligns the measurement light emitted from said light emitter.

11. The optical range finder of claim 10, wherein the receiving objective lens system receives and converges a reflected measurement light,

12. The optical range finder of claim 11, wherein the light receiver receives the reflected measurement light passing through the receiving objective lens system and outputs a corresponding electrical signal.

13. The optical range finder of claim 12, wherein the controlling and analyzing circuit controls the light emitted by said light emitter, and analyzes and processes the electrical signal output from said light receiver, to determine a measured distance.

14. The optical range finder of claim 13, wherein the receiving objective lens system further comprises a first optical portion for receiving the reflected measurement light of a long-distance measured object and converging and projecting it onto the light receiving surface of the light receiver, and a second optical portion for receiving the reflected measurement light of a short-distance measured object and converging and projecting it onto the light receiving surface of said light receiver.

15. An optical range finder, comprising:
a light emitter for emitting a measurement light, the light emitter being visible;
an aligning objective lens system for aligning the measurement light emitted from said light emitter;
a receiving objective lens system for receiving and converging a reflected measurement light;
a light receiver for receiving the reflected measurement light passing through the receiving objective lens system and outputting a corresponding electrical signal, the light receiver having a surface wherein the surface is fixed at the focal point of the first optical portion of said receiving lens system;
a controlling and analyzing circuit for controlling the light emitted by said light emitter, and analyzing and processing the electrical signal output from said light receiver, so as to determine a measured distance; and
wherein the receiving objective lens system further comprises a first optical portion for receiving the reflected measurement light of a long-distance measured object and converging and projecting it onto the light receiving surface of the light receiver, the first optical portion has an optical axis parallel to an optical axis of said aligning aligning objective lens system, and a second optical portion for receiving the reflected measurement light of a short-distance measured object and converging and projecting it onto the light receiving surface of said light receiver.

16. The optical rang finder of claim 15, wherein the two optical portions of said receiving objective lens system are divided into two separate lenses.

17. The optical range finder of claim 15, wherein the receiving objective lens system is a complex lens.

18. The optical range finder of claim 15, wherein the first optical portion and the second optical portion do not overlap.
